(19) United States
(12) Patent Application Publication
(10) Pub. No.: US 2018/0308378 A1
(43) Pub. Date: Oct. 25, 2018

(54) INTERACTIVE ENVIRONMENT FOR THE LEARNING PROCESS

(71) Applicant: Björn Sundeby, Coppet (CH)

(72) Inventor: Björn Sundeby, Coppet (CH)

(21) Appl. No.: 15/956,654

(22) Filed: Apr. 18, 2018

(30) Foreign Application Priority Data
Apr. 21, 2017 (SE) 1750477-0

(51) Int. Cl. G09B 5/14; G09B 5/12; H04L 29/06

(52) U.S. Cl. CPC G09B 5/14; G09B 5/12; G06Q 50/205; H04L 65/403; H04L 63/08

(57) ABSTRACT

The present disclosure provides for a method and at least one server for providing an interactive environment for the learning process, the interactive environment being accessible by at least one user. The method comprises receiving an authentication request, the authentication request comprising identification information of a user, authenticating the user and sending content based on the identification information, wherein the content is associated with the learning process for the user. The content comprises a lesson schedule with lessons specifying each subject according to a curriculum associated with the user. The method comprises receiving a request for information regarding a specific subject, determining, based on the request, the identification information of the user and the curriculum associated with the user, what information regarding a specific subject is relevant for the user and sending the subject specific information to the electronic device.

### RELATED APPLICATION DATA

This application claims the benefit of Swedish Patent Application No. 1750477-0, filed Apr. 21, 2017, the disclosure of which is incorporated herein by reference in its entirety.

### TECHNICAL FIELD

The present disclosure relates to a method and device for method, performed in at least one server, and at least one server for providing an interactive environment for the learning process, the interactive environment being accessible by at least one user.

### BACKGROUND

In the digitalized world today, more and more services are provided digitally. Digitalization makes more and more information available to everyone on for example computers, pads and smartphones.

Today, many schools and universities provide online access to schedules and information regarding for example grades; often through a web portal. There are also online classrooms such as google classroom and Microsoft classroom. These online services handle different documents for teachers and students, organize these and enable communication between the users that are online in the virtual “classroom”.

Since schools and the learning process are such an important aspect of our society, it is important to make the process as efficient as possible.

### SUMMARY

An object of the present disclosure is to provide a method and at least one server which seek to mitigate, alleviate, or eliminate one or more of the above-identified deficiencies in the art and disadvantages singly or in any combination.

These and further objects are achieved by a method and at least one server for providing an interactive environment for the learning process where the interactive environment is accessible by at least one user; the user being for example a teacher, a student or a parent.

The present disclosure is defined by the appended claims. Various advantageous aspects of the disclosure are set forth by the appended claims as well as by the following description and the accompanying drawings.

According to some aspects, the disclosure discloses a method comprising receiving, from a camera sensor, identification information, of at least one user, comprising face recognition data captured by the camera sensor as input regarding attendance of lessons by the at least one user. In other words the camera sensor is used to capture an image of at least one user, i.e. also plural of users, in order to recognize what users that are in the field of view of the camera sensor.

According to some aspects the camera sensor is a camera sensor comprised in any of a user's electronic device, a second electronic device and a surveillance camera device. An advantage with this is that plural faces can be captured at the same time and face recognition data from all faces can be used for determining the attendance of lessons by the each user. This is a very fast and intuitive way of registration of the users present. It saves time for e.g. a teacher that instead of asking for everyone's name, which can take several minutes of a lesson, can instead focus on getting started with the subject for that specific lesson.

According to some aspects the disclosure provides for a method, performed in at least one server, for providing an interactive environment for the learning process, the interactive environment being accessible by at least one user. The method comprises receiving, from an electronic device, an authentication request, the authentication request comprising identification information of a user, authenticating the user, sending, to the electronic device, content based on the identification information, wherein the content is associated with the learning process for the user. The content comprises a lesson schedule with lessons specifying each subject according to a curriculum associated with the user. The method further comprises receiving, from the electronic device, a request for information regarding a specific subject, determining, based on the request, the identification information of the user and the curriculum associated with the user, what information regarding a specific subject is relevant for the user and sending the subject specific information to the electronic device. One advantage with this is that an interactive environment for the learning process is provided which is secure, due to the authentication procedure. Another advantage is that the content provided for the user is specific for the authenticated user and thus personalized. Furthermore, the lesson schedule provided to the user is associated to a curriculum associated with the user. A further advantage is that the user can request information regarding a specific subject and receive information that is based on the curriculum. In other words a student can request information regarding a specific subject and know that the information she/he receives is the information specified in a curriculum for the subject. The subject specific information according to a curriculum is also relevant for a parent using the method to see what information her/his child is supposed to work on. For a teacher it is a good tool to use to, for example, plan lessons. The present disclosure thus provides for an environment that makes information regarding the learning process easily available for all parts in the process; such as teachers, students, parents and principals.

According to some aspects the disclosure provides for a method, performed in at least one server, for providing an interactive environment for the learning process, the interactive environment being accessible by at least one user. The method comprises receiving, from an electronic device, an authentication request, the authentication request comprising identification information of a user, authenticating the user, sending, to the electronic device, content based on the identification information, wherein the content is associated with the learning process for the user. The content comprises a lesson schedule with lessons specifying each subject according to a curriculum associated with the user. The method further comprises receiving, from the electronic device, a request for information regarding a specific subject, determining, based on the request, the identification information of the user and the curriculum associated with the user, what information regarding a specific subject is relevant for the user. According to some aspects, the method comprising determining, based on the request, the identification information of the user, the curriculum associated with the user and the input regarding attendance of lessons by the at least one user, what information regarding a specific subject is relevant for the user. This is followed by sending the subject specific information to the electronic device. One advantage with this is that an interactive environment for the learning process is provided which is secure, due to the authentication procedure. Another advantage is that the content provided for the user is specific for the authenticated user and thus personalized. Furthermore, the lesson schedule provided to the user is associated to a curriculum associated with the user. A further advantage is that the user can request information regarding a specific subject and receive information that is based on the curriculum. In other words a student can request information regarding a specific subject and know that the information she/he receives is the information specified in a curriculum for the subject. The subject specific information according to a curriculum is also relevant for a parent using the method to see what information her/his child is supposed to work on. For a teacher it is a good tool to use to, for example, plan lessons. The present disclosure thus provides for an environment that makes information regarding the learning process easily available for all parts in the process; such as teachers, students, parents and principals.

According to some aspects the method comprising receiving from an electronic device, an authentication request, the authentication request comprising identification information of a user comprising face recognition data captured by a camera sensor of the user's electronic device and authenticating the user by determining if the received face recognition data matches face recognition data stored in the at least one server. An advantage with this type of authentication is that it is fast and intuitive for the user.

According to some aspects, the method comprises receiving and storing, from the electronic device, information regarding what subject specific information has been handled during lessons. Thus, a user can indicate what subject specific information has been handled. A teacher can for example use a checklist and tic of what subjects has been processed. The information can thereafter for example be used for the teacher to keep track of lesson planning so that all information according to the curriculum is handled during the semesters. Students can also for example send information regarding what information she/he is familiar with and what information she/he needs to work further with. Parents can use the information to help their children to be in phase with the lessons.

According to some aspects, the method comprises comparing information regarding what subject specific information has been handled during lessons with the curriculum associated with the user and determining whether the user is in phase with the curriculum. In other words, the system can determine whether a teacher is following the curriculum and if a student has assimilated the information according to the curriculum according to a pre-determined time schedule.

According to some aspects, the method comprises sending an alert to the electronic device if the user is out of phase with the curriculum. In other words, the user receives an alert on her/his electronic device when it is determined that the user is out of phase with the curriculum. This information is relevant for any kind of user, teachers, students, parents and principals, to know if any kind of extra resource is needed for a teacher or student falling behind. According to some aspects, the method comprises sending an alert to a second electronic device if the user is out of phase with the curriculum, wherein the second electronic device is used by a second user. In other words, if the first user is for example a student, an alert may be sent to a teacher, a parent or a principal if the student is falling behind in the planned subjects to be studied.

According to some aspects, the at least one user is a teacher. As discussed above, there are many advantages with the described method for a teacher.

According to some aspects, the method comprises sending a request for input regarding attendance of lessons by specified students and receiving input regarding attendance of lessons by specified students. Thus, the teacher can log attendance of the students directly in her/his electronic device, which may be a portable electronic device, such as a smart phone.

According to some aspects, the method comprises receiving a lesson plan from the teacher regarding at least one lesson of a subject and updating stored subject specific information based on the lesson plan. An advantage with this is that teachers may use the electronic device to plan lessons and the subject specific information will be updated according to the plan. Thus, students will be able to receive information via their electronic devices based on the curriculum and on their teacher's lesson plans.

According to some aspects, the method comprises sending a request for input regarding grades of specified students and receiving input regarding grades of specified students. Thus, the system may be used for grading students. This is a very convenient way for teachers to set grades.

According to some aspects, the method comprises receiving an information test from the teacher regarding a specific subject and updating stored subject specific information based on the information test. In other words, the teacher may use the electronic device to make information tests that are then stored by the at least one server. The subject specific information thus comprises the information test. Since information according to the curriculum can be provided to the teacher, a simple way of constructing test based on the information is provided.

According to some aspects, the at least one user is a student. As discussed above, there are many advantages with the described method for a student.

According to some aspects, the method comprises sending a request for information regarding a specific lesson and receiving input information regarding the specific lessons. An advantage with this is that it makes it easy to collect information such as lesson reviews from students. Students can also for example indicate what parts of the lessons she/he has understood or not. This for example enables better records for what students are in phase and/or what teachers are providing lessons that are appreciated by students.

According to some aspects, the at least one user is a parent. As discussed above, there are many advantages with the described method for a parent.

According to some aspects, the method comprises receiving a request for output regarding attendance of lessons by specified students and sending output regarding attendance of lessons by specified students. Thus, parents can easily see if their children have attended the lessons they should.

According to some aspects, the curriculum is a national curriculum. In other words, the interactive environment for the learning process will contain information according to the national curriculum of the relevant country for the users.

According to some aspects the disclosure provides for at least one server, for providing an interactive environment for the learning process, the interactive environment being accessible by at least one user. The server comprises a communication interface and processing circuitry. The processing circuitry is configured to cause the server to receive, from an electronic device via the communication interface, an authentication request, the authentication request comprising identification information of a user, authenticate the user and send, to the electronic device via the communication interface, content based on the identification information, wherein the content is associated with the learning process for the user. The content comprises a lesson schedule with lessons specifying each subject according to a curriculum associated with the user. The processing circuitry is further configured to cause the server to receive, from the electronic device via the communication interface, a request for information regarding a specific subject, determine, based on the request, the identification information of the user and the curriculum associated with the user, what information regarding a specific subject is relevant for the user and send, via the communication interface, the subject specific information to the electronic device. The advantages of the at least one server are the same as the ones discussed above in connection to the method.

### BRIEF DESCRIPTION OF THE DRAWINGS

The foregoing will be apparent from the following more particular description of the example aspects, as illustrated in the accompanying drawings in which like reference characters refer to the same parts throughout the different views. The drawings are not necessarily to scale, emphasis instead being placed upon illustrating the example aspects.

FIG. 1 illustrates at least one server according to some aspects of the disclosure.

FIGS. 2-6 are flow charts illustrating the proposed method.

### DETAILED DESCRIPTION

Aspects of the present disclosure will be described more fully hereinafter with reference to the accompanying drawings. The method and server disclosed herein can, however, be realized in many different forms and should not be construed as being limited to the aspects set forth herein.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Aspects of the present disclosure will be exemplified using an electronic device such as a mobile phone. Examples of such devices may for instance be any type of mobile phone, smartphone, laptop (such as standard, ultra portables, netbooks, and micro laptops) handheld computers, portable digital assistants, tablet computers, touch pads, gaming devices, accessories to mobile phones, e.g. wearables, etc. For the sake of clarity and simplicity, the aspects outlined in this specification are exemplified with, and related to, mobile phones.

As discussed in the summary, an object of the present disclosure is to provide a method and at least one server for providing an interactive environment for the learning process where the interactive environment is accessible by at least one user; the user being for example a teacher, a student or a parent.

An example of use of the interactive environment according to the disclosure is as follows. A teacher has an app on her/his smartphone, i.e. electronic device, with the interactive environment for the learning process. The teacher has logged in on the app so that the system recognizes which user in using the app. The teacher then has access to her/his schedule, with all lessons planned. The teacher also has access to curriculum specific information for each type of lesson. Say that the teacher is a mathematics teacher for an 8^{th} grade class in Sweden. I the teacher then selects a subject on her/his calendar she/he receives curriculum specific information regarding that subject. In other words, the teacher can look into the curriculum for her/his specific classes using her/his app. This greatly simplifies the lesson planning for the teacher by making curriculum specific information accessible via her/his teacher calendar in the app. So, before a specific lesson, the teacher looks in the app, selects the lesson and requests curriculum specific information associated with the class. She/he then receives information regarding what subjects should be handled during the class. It may also be possible for the teacher to mark, in the app, what information has already been handled during class, so that it is easy to get an overview over what has been done and what is still to be done. The information specified in the curriculum that is accessible via the app is also useful when the teacher is constructing exams. It makes it easier for the teacher to make sure that she/he does not test anything outside of the curriculum.

According to some aspects, the teacher can also enter a time plan in the curriculum associated information so that she/he can be sure to be able to cover everything during the semester. Other information that the teacher may receive from the at least one server is a list of students that are listed for each class. This enables the teacher to, for example during class, to tic of, directly in the app, which students are attending the class. Another example is that the teacher may enter grades directly in the app for a more efficient handling of grades.

Another example of use is when a student is using the interactive environment in an app in her/his smartphone. The student is also required to log in to the environment. Like the teacher, the student has access to her/his schedule and to the curriculum associated information. For the student, the curriculum associated information will be highly useful because she/he can look up information that has been handled during class. If the teacher has indicated what information has already been processed during lessons, the student can check whether she/he has understood all material that she/he should already know. It may also be possible for the student to tic of what information she/he considers herself/himself to know already. It may also be possible for the students to see past attendance and grades of already attended classes.

An example of use for parents of children attending lessons is that the parent is able to, after logging in, follow the progress of her/his child as well as seeing what lessons the child has attended and not. The parent may also see the curriculum specific information and thus being able to take a more active role in the learning process for the child. If the parent sees that the child is currently working with information regarding the World War II, the parent may for example take the opportunity to go to a museum covering the war.

The app for the teacher is a variant of a teacher calendar, in Swedish “lärarkalender”. The graphical interface of the app may be a graphical imitation of the format of a physical teacher calendar. In other words, the app may for example have a graphical interface that mimics that of a physical calendar that the teacher has. The app may look the same for other types of users of the app, such as students, parents or principals. The app may also have different graphical profiles for different types of users.

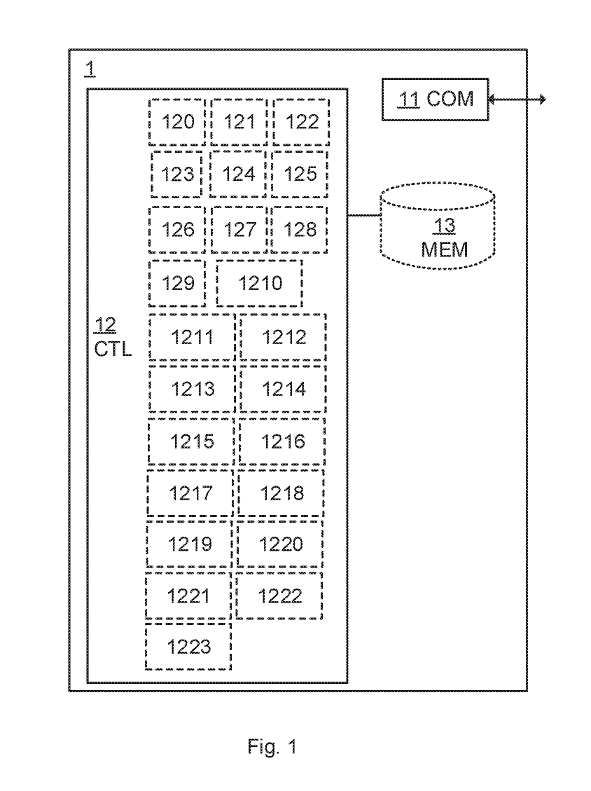

FIG. 1 is a schematic illustration of a server according to some aspects of the disclosure. The server 1 is illustrated as a box containing communication circuitry 11, processing circuitry 12 and a memory 13. Today, however, many methods are implemented in the cloud and the cloud can be seen as consisting of a network of servers. Thus, the method according to the disclosure does not necessarily have to be performed in one server but in at least one server. In other words, the illustration in FIG. 1 can be seen as to represent at least one server. The at least one server is in some way connected to communication circuitry and storage means. The “cloud” is a well-known concept and will not be described further. So, FIG. 1 illustrates at least one server 1, for providing an interactive environment for the learning process, the interactive environment being accessible by at least one user. The server comprises a communication interface 11 and processing circuitry 12. The at least one server is for example implemented in the cloud. The memory 13 is any kind of data storage where it is possible for the at least one server to store and retrieve data.

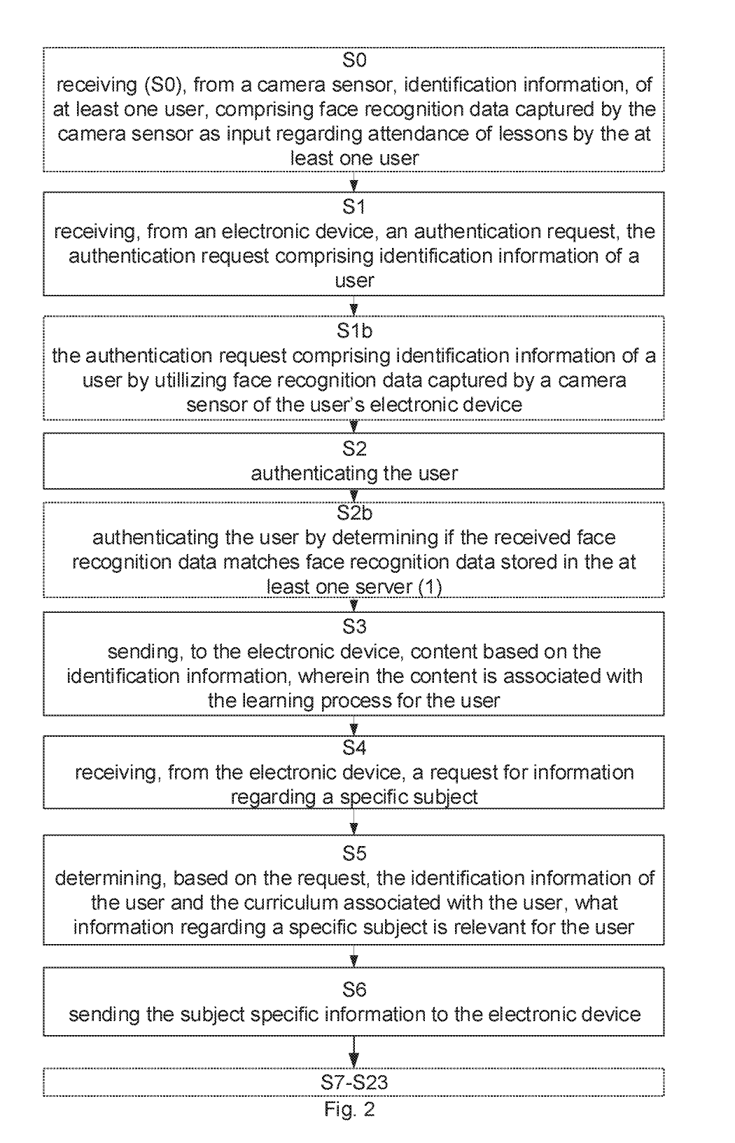

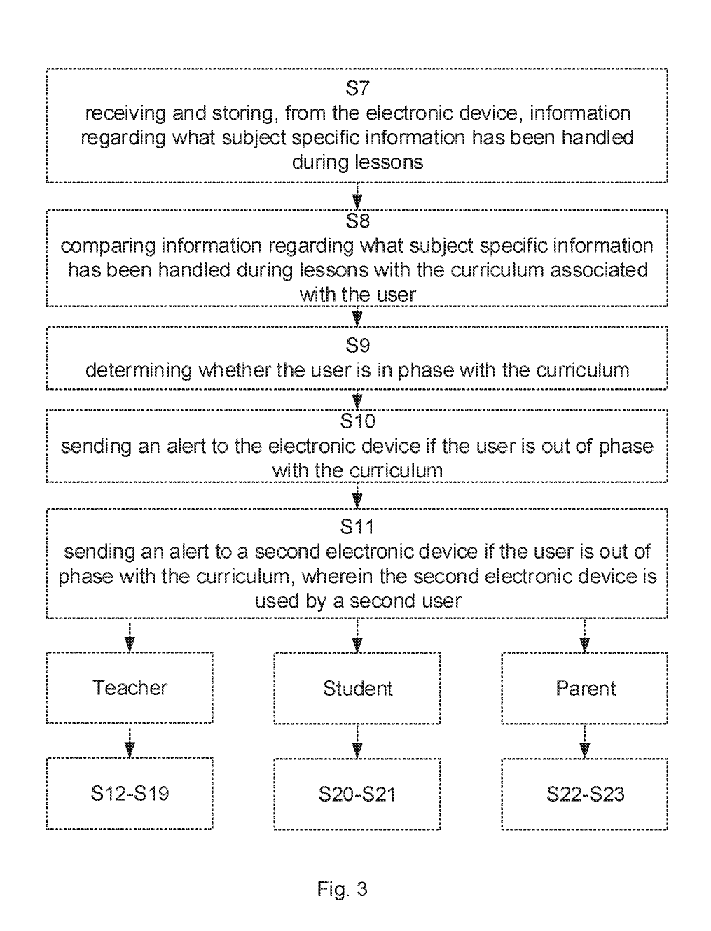

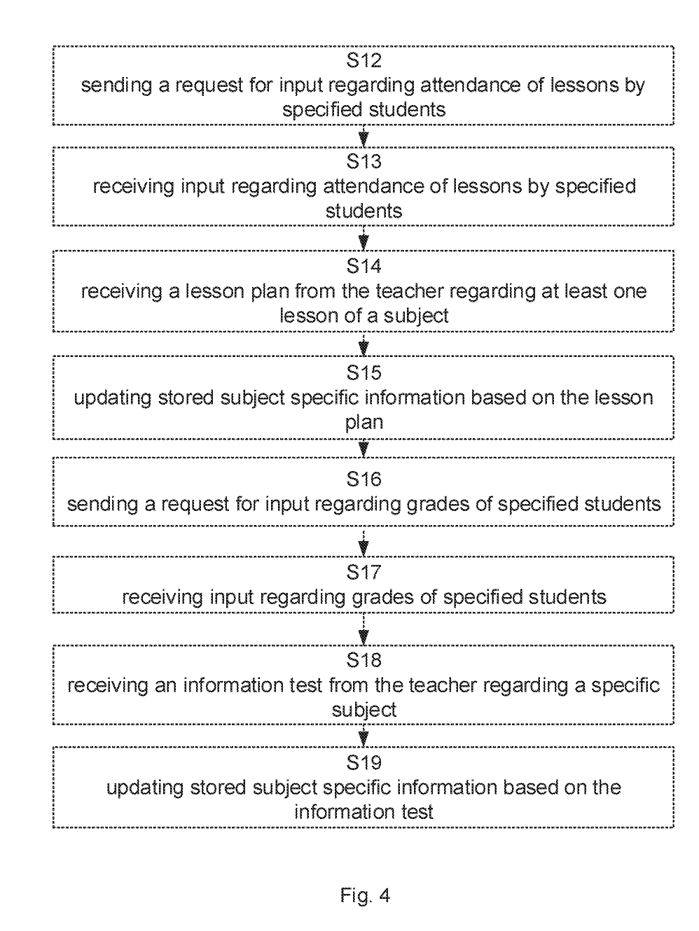

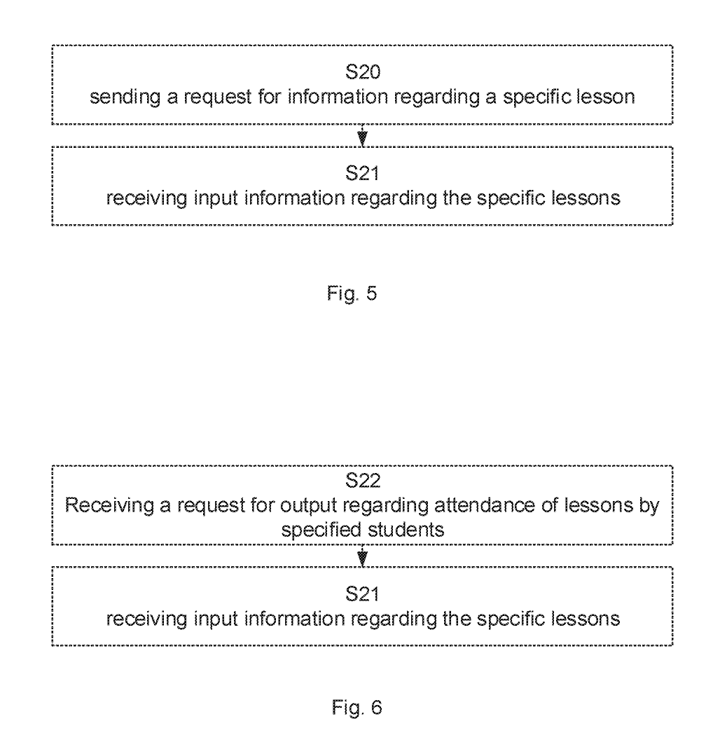

FIGS. 2-6 illustrates a block diagram of the method steps according to some aspects of the disclosure. The blocks with a solid line represent the steps that are part of the broadest aspect and the blocks with dotted lines are example aspects of the disclosure. It should be noted that the blocks are not necessarily performed in the illustrated order.

As also shown in FIGS. 2-6, according to some aspects the disclosure provides for a method, performed in at least one server 1, for providing an interactive environment for the learning process, the interactive environment being accessible by at least one user. The interactive environment is for example provided in an app in a smartphone. So with the term interactive environment, an environment in for example an app is intended. The environment allows for interaction between the user and the back end system in the at least one server.

According to some aspects, the disclosure provides for a method comprising receiving S0, from a camera sensor, identification information, of at least one user, comprising face recognition data captured by the camera sensor as input regarding attendance of lessons by the at least one user. In other words the camera sensor is used to capture an image of at least one user, e.g. plural students in a class room, in order to recognize what users that is in the field of view of the camera sensor. By using face recognition and determining what users that are present, it can be determined who is attending the lesson. According to an aspect the method comprising determining if the face recognition data matches face recognition data stored in the at least one server. In one example existing face recognition data is associated with personal information, e.g. information about each student in a school, that is stored in the at least one server.

An advantage with knowing the attendance of lessons by the at least one user is not only for e.g. teachers and parents general interest but the information can also be used for determining what information regarding a specific subject is relevant for the user. The information can also be used for e.g. planning of repeating a lesson for certain identified users that have not attended the certain lesson.

According to some aspects the camera sensor is a camera sensor comprised in any of a user's electronic device, a second electronic device and a surveillance camera device. The camera sensor can for example be the camera in the user's smartphone that the user is using to access the server. The camera sensor can also be the camera sensor of a second electronic device such as the teacher's smartphone or tablet. The teacher can capture an image of the at least one user in order to determine the attendance of lessons by the at least one user. An advantage with this is that plural faces can be captured at the same time and face recognition data from all faces can be used for determining the attendance of lessons by the each user. This is a very fast and intuitive way of registration of the users present. It saves time for e.g. a teacher that instead of asking for everyone's name, which can take several minutes of a lesson, can instead focus on getting started with the subject for that specific lesson. The camera sensor can also be an installed surveillance camera device, e.g. installed in the class room that is connected to the server. According to an aspect, the face recognition data captured by the camera sensor is continuously updated. In other words the information about attendance of lessons by the at least one user can be determined to e.g. number of minutes during a certain lesson.

According to some aspects the method comprises receiving S1, from an electronic device, an authentication request, the authentication request comprising identification information of a user and authenticating S2 the user. The at least one server receives S1, via the communication circuitry 11, the request. According to some aspects, the server comprises a receiving module 121 adapted to receive the request. According to some aspects, the server comprises an authenticating module 122 adapted to authenticate the user. The authentication request comprises for example a username and a password. The authenticating comprises for example to check the username and that the password is the correct password for the username. The authentication of the user can also be done using for example fingerprint information sent together with identification information from the smartphone. The authentication of the user can also be done by using for example the Swedish service “mobilt BankID” or something similar. There are several ways to authenticate a user in an app in a smartphone and all of them are possible to use. According to some aspects the method comprises receiving from an electronic device, an authentication request, the authentication request comprising identification information of a user comprising face recognition data captured by a camera sensor of the user's electronic device and authenticating the user by determining if the received face recognition data matches face recognition data stored in the at least one server 1.

An advantage with this type of authentication is that it is fast and intuitive for the user. According to an aspect the camera sensor is e.g. a front facing camera of a smartphone that the user is holding in the hand when accessing the server. In one example the user interface of the smartphone is prompting the user to place the face in a certain area indicated for face detection. An advantage with utilizing face recognition data captured by a camera sensor for the authentication request is that it is a very easy and smooth way for getting access for the user.

It should be noted that information associated with the learning process is sensitive information that usually confidential information only to be shared between the school and specific users, therefore the information sent back and forth between the at least one server and the electronic device of the user is encrypted. The method of encrypting the information is irrelevant for the present disclosure.

The method also comprises sending S3, to the electronic device, content based on the identification information, wherein the content is associated with the learning process for the user. The at least one server sends S3, via the communication circuitry 11, content. According to some aspects, the server comprises a sending module 123 adapted to send the content. The learning process is here used as a term that incorporates all steps of the process where at least one student is to learn a material of a specified subject or in other words learn more and get an enhanced knowledge of a specified subject; in other words the process of learning.

The content comprises a lesson schedule with lessons specifying each subject according to a curriculum associated with the user. In other words, the content sent to the electronic device is at least a schedule with the lessons that the student is attending. The lessons also specify what subject is to be processed during the lessons and the subject is curriculum specific for the student. A curriculum for a student is different depending on where the student lives and her/his age. The curriculum may also depend on what kind of program or focus areas the student has chosen. In Sweden such a program is for example “Naturvetenskapligt Program”, “Ekonomiskt Program”, etc. The curriculum may be defined as the total learning experience provided by a school. It may include the content of courses (the syllabus), the methods employed (strategies), and other aspects, like norms and values, which relate to the way the school is organized. Curriculum may refer to the entire program provided by a classroom, school, district, state, or country.

The method further comprises receiving S4, from the electronic device, a request for information regarding a specific subject. The at least one server receives S4, via the communication circuitry 11, the request. According to some aspects, the server comprises a receiving module 124 adapted to receive the request. The subject specific information is for example curriculum specified content for the lesson, grade for a student taking the class/lesson of the subject, attendance for the class/lesson of the subject, list of students taking the classes/lessons of the subject etc.

The method further comprises determining S5, based on the request, the identification information of the user and the curriculum associated with the user, what information regarding a specific subject is relevant for the user. According to some aspects, the method comprises determining, based on the request, the identification information of the user, the curriculum associated with the user and the input regarding attendance of lessons by the at least one user, what information regarding a specific subject is relevant for the user. This is followed by sending S6 the subject specific information to the electronic device. According to some aspects, the server comprises a determining module 125 adapted to determine the relevant information. The at least one server sends S6, via the communication circuitry 11, the subject specific information. According to some aspects, the server comprises a sending module 126 adapted to send the information. In other words, only information relevant to the specific user of the electronic device will be sent. The subject specific information is, in the case of request for information regarding the content of the subject, curriculum specific to the user. For example, if the lesson is history and the user is a student that requests information regarding the content of the next lesson, she/he will receive, via the electronic device, the information that is to be covered during that lesson and the information will be based on the curriculum that has been set for that specific class. According to some aspects, the at least one server has access to curriculum specific information.

One advantage with this is that an interactive environment for the learning process is provided which is secure, due to the authentication procedure. Another advantage is that the content provided for the user is specific for the authenticated user and thus personalized. Furthermore, the lesson schedule provided to the user is associated to a curriculum associated with the user. A further advantage is that the user can request information regarding a specific subject and receive information that is based on the curriculum. In other words a student can request information regarding a specific subject and know that the information she/he receives is the information specified in a curriculum for the subject. The subject specific information according to a curriculum is also relevant for a parent using the method to see what information her/his child is supposed to work on. For a teacher it is a good tool to use to, for example, plan lessons. The present disclosure thus provides for an environment that makes information regarding the learning process easily available for all parts in the process; such as teachers, students, parents and principals.

The method comprises, according to some aspects, receiving and storing S7, from the electronic device, information regarding what subject specific information has been handled during lessons. According to some aspects, the at least one server stores S7, in the memory 13, the information. According to some aspects, the server comprises a storing module 127 adapted to store the information. A possible way to do this is to provide a box to tic in connection to the information on the electronic device. In other words, the user can make a mark regarding what information has been handled. Thus, a user can indicate what subject specific information has been handled. A teacher can for example use a checklist and tic of what subjects has been processed. The information can thereafter for example be used for the teacher to keep track of lesson planning so that all information according to the curriculum is handled during the semesters. Students can also for example send information regarding what information she/he is familiar with and what information she/he needs to work further with. Parents can use the information to help their children to be in phase with the lessons.

The at least one server will handle a lot of information of many aspects of the learning process. This enables for that, according to some aspects, the method comprises comparing S8 information regarding what subject specific information has been handled during lessons with the curriculum associated with the user and determining S9 whether the user is in phase with the curriculum. According to some aspects, the server comprises a comparing module 128 adapted to do the comparison. According to some aspects, the server comprises a determining module 129 adapted to determine whether the user is in phase. In other words, it can be determined whether all students are synchronized with the schedule. In other words, it can be determined whether the students taking a class are up to date with what information should have been handled. In other words, the system can determine whether a teacher is following the curriculum and if a student has assimilated the information according to the curriculum according to a pre-determined time schedule.

That the at least one server determines whether a user is in phase with the curriculum enables for the method to, according to some aspects, comprise sending S10 an alert to the electronic device if the user is out of phase with the curriculum. The at least one server sends S10, via the communication circuitry 11, the alert. According to some aspects, the server comprises an alerting module 1210 adapted to send the alert. The alert can be indicated in many ways on the electronic device. The requirement is that it is made visible for the user so that the user does not miss an alert that the user is out of phase. The sending of an alert comprises according to some aspects instructions to the electronic device to display an alert to the user. The user can select the alert to see the details of the alert. In other words, the user receives an alert on her/his electronic device when it is determined that the user is out of phase with the curriculum. This information is relevant for any kind of user, teachers, students, parents and principals, to know if any kind of extra resource is needed for a teacher or student falling behind. According to some aspects, the method comprises sending S11 an alert to a second electronic device if the user is out of phase with the curriculum, wherein the second electronic device is used by a second user. The at least one server sends S11, via the communication circuitry 11, alert to a second device. According to some aspects, the server comprises an alerting module 1211 adapted to send the alert. In other words, if the first user is for example a student, an alert may be sent to a teacher, a parent or a principal if the student is falling behind in the planned subjects to be studied. According to some aspects the alert is also sent due to another reason than a user being out of phase. Another reason for sending an alert may for example be to send an alert to a user being a parent that their child has not attended a class that she/he was supposed to attend. Another reason for sending an alert may for example be if students of a class have graded the teacher and the teacher has received low grades. Then an alert may be sent to the principal and/or to the teacher. Another reason to send an alert is if a teacher is falling behind the schedule according to the curriculum so that there is a risk that not all subjects defined in the curriculum will be handled in time. An alert in this case may for example go to a principal and/or to the teacher.

As previously discussed, according to some aspects, the at least one user is a teacher. As also discussed above, there are many advantages with the described method for a teacher.

When the user is a teacher, the method comprises, according to some aspects, sending S12 a request for input regarding attendance of lessons by specified students and receiving S13 input regarding attendance of lessons by specified students. The at least one server sends S11 and receives S13, via the communication circuitry 11, the input. According to some aspects, the server comprises a sending module 1212 and a receiving module 1213 adapted to send and receive the input. Thus, the teacher can log attendance of the students directly in her/his electronic device, which may be a portable electronic device, such as a smart phone. The request from the at least one sever comprises for example a list of the students taking a specific class where the teacher can tic a box for each attending student. The request for input regarding attendance is sent on the time of start of the relevant lesson or at least in connection there to.

Furthermore, when the user is a teacher, the method comprises, according to some aspects, receiving S14 a lesson plan from the teacher regarding at least one lesson of a subject and updating S15 stored subject specific information based on the lesson plan. The at least one server receives S14, via the communication circuitry 11, the plan. According to some aspects, the server comprises a receiving module 1214 adapted to receive and an updating module 1215 adapted to update the stored information on the memory. In other words, the teacher may use the electronic device to plan lessons, for example by marking in the subject specific information what information will be handled during which lessons. An advantage with this is that teachers may use the electronic device to plan lessons and the subject specific information will be updated according to the plan. Thus, students will be able to receive information via their electronic devices based on the curriculum and on their teacher's lesson plans. In other words, using an electronic device such as a smartphone, students can check what information will be handled during which classes and also receive the information that will be handled. This will greatly simplify the learning process for the students and make all information easily accessible to the students.

As previously discussed, the method comprises, according to some aspects, sending S16 a request for input regarding grades of specified students and receiving S17 input regarding grades of specified students. The at least one server sends S16 and receives S17, via the communication circuitry 11, the request and the input respectively. According to some aspects, the server comprises a sending module 1216 adapted to send the request and a receiving module 1217 adapted to receive the input. Thus, the system may be used for grading students. This is a very convenient way for teachers to set grades. The at least one server sends for example a request comprising a list of students where it is possible to insert grades for each student. According to some aspects, the request also comprises, for each student, information that the teacher has previously inserted, such as attendance and grades for specific projects or parts of the subject that has been handled, so that the teacher receives an overall picture of how the student has done previously in the class. The teacher can then easily make an informed choice of grade for the students.

As also previously discussed, the teacher may use the app on her/his electronic device to construct information tests to the students. Thus, according to some aspects, the method comprises receiving S18 an information test from the teacher regarding a specific subject and updating S19 stored subject specific information based on the information test. The at least one server receives S18, via the communication circuitry 11, the information test. According to some aspects, the server comprises a receiving module 1218 adapted to receive the information test and an updating module 1219 adapted to update the subject specific information. In other words, the teacher may use the electronic device to make information tests that are then stored by the at least one server. The subject specific information thus comprises the information test. Since information according to the curriculum can be provided to the teacher, a simple way of constructing test based on the information is provided. One way of constructing such a test is for example that the teacher chooses subject specific questions that are suggested to the teacher from the subject specific information. Another way is that the teacher can insert her/his own question in connection to a specific text of subject specific information. The test may be used by printing it and having a conventional paper test or that the students are sent their test on their electronic device at a specific time. There are many ways of assuring that the students do not cheat on such a test. One way is to have a setting in the app that is activated with the start of the test which looks the electronic device to the app when the test is active and thus preventing the student to search for answers in other apps on the device. One way to prevent the students to work together is to simply have them all gathered in a classroom for the test to be able to supervise the test. Another way is to use the camera and microphone during the test time. The camera and microphone of the electronic device may thus be activated during the test time and the recordings can be sent to the teacher such that the teacher can see and hear that the student performed the test without discussing the answers with anyone else. The above ways to prevent cheating may of course be combined.

As previously discussed, according to some aspects, the at least one user is a student. As discussed above, there are many advantages with the described method for a student. When the user is a student, the method comprises, according to some aspects, sending S20 a request for information regarding a specific lesson and receiving S21 input information regarding the specific lessons. The at least one server sends S20 and receives S21, via the communication circuitry 11, the request and the input respectively. According to some aspects, the server comprises a sending module 1220 adapted to send the request and a receiving module 1221 adapted to receive the input. The information request is for example a request for a review of the specific lesson or of the all of the lessons of the associated subject or a review of the teacher or teachers holding the lessons. An advantage with this is that it makes it easy to collect information such as lesson reviews from students. Students can also for example indicate what parts of the lessons she/he has understood or not. This for example enables better records for what students are in phase and/or what teachers are providing lessons that are appreciated by students. In other words, the input is for example a confirmation from the student that the information received during the lesson has been understood. The input from the student may also be an indication of that the student needs more information or more explanation regarding a subject. According to some aspects, the request is not sent but it is optional for the student to input the above information.

As previously discussed, according to some aspects, the at least one user is a parent. As discussed above, there are many advantages with the described method for a parent.

When the user is a parent, according to some aspects, the method comprises receiving S22 a request for output regarding attendance of lessons by specified students and sending S23 output regarding attendance of lessons by specified students. The at least one server receives S22 and sends S23, via the communication circuitry 11, the request and the output respectively. According to some aspects, the server comprises a receiving module 1222 adapted to receive the request and a sending module 1223 adapted to send the output. In other words, a user in the form of a parent can request attendance information regarding their child so that she/he can keep track of their child's school activity. Thus, parents can easily see if their children have attended the lessons they should. According to some aspects, the user does not send the request but automatically receives information regarding attendance of their child.

According to some aspects, the curriculum is a national curriculum. In other words, the interactive environment for the learning process will contain information according to the national curriculum of the relevant country for the users. A national curriculum is a curriculum that has been specified on a national level. A curriculum may also be, as previously described, specified on a state level, a city level or a school level. A curriculum may also be specified by a combination of those, so that some parts are specified on one level and other parts are specified on another level. The curriculum is off course different for different ages and/or for different programs or subject areas.

As previously discussed, the disclosure provides for at least one server 1, for providing an interactive environment for the learning process, the interactive environment being accessible by at least one user. The server comprises a communication interface 11 and processing circuitry 12. The processing circuitry is configured to cause the server 1 to receive, from an electronic device via the communication interface, an authentication request, the authentication request comprising identification information of a user, authenticate the user and send, to the electronic device via the communication interface, content based on the identification information, wherein the content is associated with the learning process for the user. The content comprises a lesson schedule with lessons specifying each subject according to a curriculum associated with the user. The processing circuitry is further configured to cause the server (1) to receive, from the electronic device via the communication interface, a request for information regarding a specific subject, determine, based on the request, the identification information of the user and the curriculum associated with the user, what information regarding a specific subject is relevant for the user and send, via the communication interface, the subject specific information to the electronic device. The advantages of the at least one server are the same as the ones discussed above in connection to the method.

The description of the example aspects provided herein have been presented for purposes of illustration. The description is not intended to be exhaustive or to limit example aspects to the precise form disclosed, and modifications and variations are possible in light of the above teachings or may be acquired from practice of various alternatives to the provided aspects. The examples discussed herein were chosen and described in order to explain the principles and the nature of various example aspects and its practical application to enable one skilled in the art to utilize the example aspects in various manners and with various modifications as are suited to the particular use contemplated. The features of the aspects described herein may be combined in all possible combinations of methods, apparatus, modules, systems, and computer program products. It should be appreciated that the example aspects presented herein may be practiced in any combination with each other.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example aspects may be implemented at least in part by means of both hardware and software, and that several “means”, “units” or “devices” may be represented by the same item of hardware.

The various example aspects described herein are described in the general context of method steps or processes, which may be implemented according to some aspects by a computer program, comprising computer readable code which, when run on an server, causes the server to perform the method according to above. The computer program, embodied in a computer-readable medium, includes computer-executable instructions, such as program code, executed by computers in networked environments. A computer-readable medium may include removable and non-removable storage devices including, but not limited to, Read Only Memory, ROM, Random Access Memory, RAM, compact discs, CDs, digital versatile discs, DVD, etc. Generally, program modules may include routines, programs, objects, components, data structures, etc. that performs particular tasks or implement particular abstract data types. Computer-executable instructions, associated data structures, and program modules represent examples of program code for executing steps of the methods disclosed herein.

In the drawings and specification, there have been disclosed exemplary aspects. However, many variations and modifications can be made to these aspects. Accordingly, although specific terms are employed, they are used in a generic and descriptive sense only and not for purposes of limitation, the scope of the aspects being defined by the following claims.

What is claimed is:

1. A method, performed in at least one server, for providing an interactive environment for the learning process, the interactive environment being accessible by at least one user, the method comprising:
receiving, from an electronic device, an authentication request, the authentication request comprising identification information of a user;
authenticating the user;
sending, to the electronic device, content based on the identification information, wherein the content is associated with the learning process for the user;
wherein the content comprises a lesson schedule with lessons specifying each subject according to a curriculum associated with the user;
receiving, from the electronic device, a request for information regarding a specific subject;
determining, based on the request, the identification information of the user and the curriculum associated with the user, what information regarding a specific subject is relevant for the user; and
sending the subject specific information to the electronic device.

2. The method according to claim 1 further comprising
receiving, from a camera sensor, identification information, of at least one user, comprising face recognition data captured by the camera sensor as input regarding attendance of lessons by the at least one user.

3. The method according to claim 2, wherein determining what information regarding a specific subject is relevant for the user is further based on the input regarding attendance of lessons by the at least one user.

4. The method according to claim 2, wherein the camera sensor is a camera sensor comprised in any of:
a user's electronic device
a second electronic device
a surveillance camera device

5. The method according to claim 1, comprising:
receiving, from an electronic device, an authentication request, the authentication request comprising identification information of a user comprising face recognition data captured by a camera sensor of the user's electronic device;
authenticating the user by determining if the received face recognition data matches face recognition data stored in the at least one server.

6. The method according to claim 1, comprising:
receiving and storing, from the electronic device, information regarding what subject specific information has been handled during lessons.

7. The method according to claim 6, comprising:
comparing information regarding what subject specific information has been handled during lessons with the curriculum associated with the user; and
determining whether the user is in phase with the curriculum.

8. The method according to claim 7, comprising:
sending an alert to the electronic device if the user is out of phase with the curriculum.

9. The method according to claim 7, comprising:
sending an alert to a second electronic device if the user is out of phase with the curriculum, wherein the second electronic device is used by a second user.

10. The method according to claim 1, wherein the at least one user is a teacher.

11. The method according to claim 10, comprising:
sending a request for input regarding attendance of lessons by specified students; and
receiving input regarding attendance of lessons by specified students.

12. The method according to claim 10, comprising:
receiving a lesson plan from the teacher regarding at least one lesson of a subject; and
updating stored subject specific information based on the lesson plan.

13. The method according to claim 10, comprising:
sending a request for input regarding grades of specified students; and
receiving input regarding grades of specified students.

14. The method according to claim 10, comprising:
receiving an information test from the teacher regarding a specific subject; and
updating stored subject specific information based on the information test.

15. The method according to claim 1, wherein the at least one user is a student.

16. The method according to claim 15, comprising:
sending a request for information regarding a specific lesson; and
receiving input information regarding the specific lessons.

17. The method according to claim 1, wherein the at least one user is a parent.

18. The method according to claim 17, comprising:
receiving a request for output regarding attendance of lessons by specified students; and
sending output regarding attendance of lessons by specified students.

19. The method according to claim 1, wherein the curriculum is a national curriculum.

20. At least one server, for providing an interactive environment for the learning process, the interactive environment being accessible by at least one user, the server comprising:
a communication interface;
processing circuitry configured to cause the server to:
receive, from an electronic device via the communication interface, an authentication request, the authentication request comprising identification information of a user;
authenticate the user;
send, to the electronic device via the communication interface, content based on the identification information, wherein the content is associated with the learning process for the user;
wherein the content comprises a lesson schedule with lessons specifying each subject according to a curriculum associated with the user;
receive, from the electronic device via the communication interface, a request for information regarding a specific subject;
determine, based on the request, the identification information of the user and the curriculum associated with the user, what information regarding a specific subject is relevant for the user; and
send, via the communication interface, the subject specific information to the electronic device.

21. The at least one server according to claim 20, wherein the processing circuitry is further configured to cause the server to:
receive, from a camera sensor, identification information of at least one user comprising face recognition data captured by the camera sensor for input regarding attendance of lessons by the at least one user.
